(19) United States
(12) Patent Application Publication
(10) Pub. No.: US 2015/0219005 A1
(43) Pub. Date: Aug. 6, 2015

(54) METHOD OF IMPROVING CHARGE AIR CONDITION IN AIR-COOLED CHARGE AIR COOLERS

(71) Applicant: HALLA VISTEON CLIMATE CONTROL CORP., Daejeon (KR)

(72) Inventors: Keith Roland Wilkins, Goldhanger Maldon (GB); Leo Somhorst, Kent (GB)

(21) Appl. No.: 14/529,342

(22) Filed: Oct. 31, 2014

Related U.S. Application Data
(60) Provisional application No. 61/934,055, filed on Jan. 31, 2014.

(51) Int. Cl. F02B 29/04; F01P 3/20

(52) U.S. Cl. CPC F02B 29/0443; F01P 3/20; F02B 29/0462; F01P 2060/02

(57) ABSTRACT

A charge air system of a motor vehicle having a charger disposed in a charge air circuit and an air-cooled charge air cooler in fluid communication with the charger. The charge air system further includes a pre-cooler is in fluid communication with the air-cooled charge air cooler and an engine coolant circuit in heat exchange communication with the pre-cooler. The engine coolant circuit configured to deliver a flow of coolant through an engine of the motor vehicle.

This application claims priority to U.S. Provisional Patent Application Ser. No. 61/934,055 filed Jan. 31, 2014, hereby incorporated herein by reference in its entirety.

### FIELD OF THE INVENTION

The invention relates to a system and method for improving charge air condition in an air-cooled charge air cooler, particularly a system and method for improving charge air condition of a motor vehicle using a pre-cooler.

### BACKGROUND OF THE INVENTION

As is commonly known, turbochargers and superchargers are used to boost an engine of a motor vehicle by compressing air prior to being received by cylinders of the engine. When the air is compressed by the turbocharger or supercharger, the air is heated and a pressure of the air is increased. However, it is desirable for the air entering an engine, such as a diesel engine or gasoline engine, to be cooled after exiting the turbocharger or supercharger because cooler air will have an increased density that improves the efficiency of the engine. In certain situations, the cooling of the air may also facilitate engine management and eliminate the danger of pre-detonation of the air and a fuel prior to a timed spark ignition and militate against excessive wear or heat damage to an engine block of the engine. Air-cooled charge air coolers can be used in the motor vehicle to cool the air that has been compressed by the turbocharger or supercharger. Examples of air-cooled charge air coolers and charge air systems are described in numerous applications such as U.S. Pat. No. 7,004,154, U.S. Pat. Appl. Pub. No. 2013/0220289, and U.S. Pat. Appl. Pub. No. 2013/0133630, all of which are hereby incorporated by reference herein in their entirety.

Typically, at high levels of turbocharger or supercharger boost, maximum performance is required from the air-cooled charge air cooler to cool the air entering the engine. During low levels of turbocharger or supercharger boost, if a humidity of the ambient air is high, however, condensation (e.g., water droplets) may form on an internal surface of the air-cooled charge air cooler that is cooler than the dew point of the compressed air. These water droplets may be discharged from the air-cooled charge air cooler and into the combustion chambers of the engine resulting in poor engine performance, misfire, or failure.

Some prior art solutions to the problem of condensate formation within the air-cooled charge air cooler have relied on modifying or detuning the air-cooled charge air cooler. This modification and detuning consequently and undesirably reduces the desired performance of the air-cooled charge air cooler, especially during the high level of turbocharger or supercharger boost.

It would therefore be desirable to provide a system and method of improving charge air condition of air-cooled charge air coolers to militate against condensate formation on the air-cooled charge air cooler surfaces while maintaining or increasing desired performance and efficiency of the air-cooled charge air cooler and maintaining package size requirements.

### SUMMARY OF THE INVENTION

In accordance and attuned with the present invention, a method of improving charge air condition of air-cooled charge air coolers to militate against condensate formation on the air-cooled charge air cooler surfaces while maintaining or increasing desired performance and efficiency of the air-cooled charge air cooler and maintaining package size requirements has surprisingly been discovered.

According to an embodiment of the invention a charge air system of a motor vehicle includes a charger disposed in a charge air circuit and an air-cooled charge air cooler in fluid communication with the charger. A pre-cooler is in fluid communication with the air-cooled charge air cooler. An engine coolant circuit is in heat exchange communication with the pre-cooler. The engine coolant circuit is configured to deliver a flow of coolant through an engine of the motor vehicle.

According to another embodiment of the invention, a charge air system of a motor vehicle includes an air charge circuit having a charger, an air-cooled charge air cooler in fluid communication with the charger, and a pre-cooler in fluid communication with and separate from the air-cooled charge air cooler. The pre-cooler is disposed upstream of the air-cooled charge air cooler. The charge air system further includes an engine coolant circuit in heat exchange communication with the air charge circuit. The engine coolant circuit conveys a flow of coolant through an engine of the motor vehicle.

According to yet another embodiment of the invention, a charge air system is disclosed. The charge air system includes a charge air circuit having a charger disposed therein. The charge air circuit is configured for delivering a flow of air from the charger to at least one cylinder of an engine of the motor vehicle. The charge air circuit has an air-cooled charge air cooler disposed downstream of the charger and configured for cooling the flow of air prior to the engine. An engine coolant circuit is separate from the charge air circuit. The engine coolant circuit has a radiator disposed therein. The engine coolant circuit is configured to deliver a flow of coolant though the engine. A pre-cooler is in fluid communication with the charge air circuit and the engine coolant circuit. The pre-cooler is configured to transfer heat between the flow of air and the flow of coolant.

### BRIEF DESCRIPTION OF THE DRAWINGS

The above, as well as other objects and advantages of the invention, will become readily apparent to those skilled in the art from reading the following detailed description of a preferred embodiment of the invention when considered in the light of the accompanying drawing which:

FIG. 1 is a schematic circuit diagram of a charge air system according to an embodiment of the invention; and

FIG. 2 is a schematic circuit diagram of a charge air system according to another embodiment of the invention.

### DETAILED DESCRIPTION OF THE INVENTION

The following detailed description and appended drawings describe and illustrate various embodiments of the invention. The description and drawings serve to enable one skilled in the art to make and use the invention, and are not intended to limit the scope of the invention in any manner. In respect of the methods disclosed, the steps presented are exemplary in nature, and thus, the order of the steps is not necessary or critical.

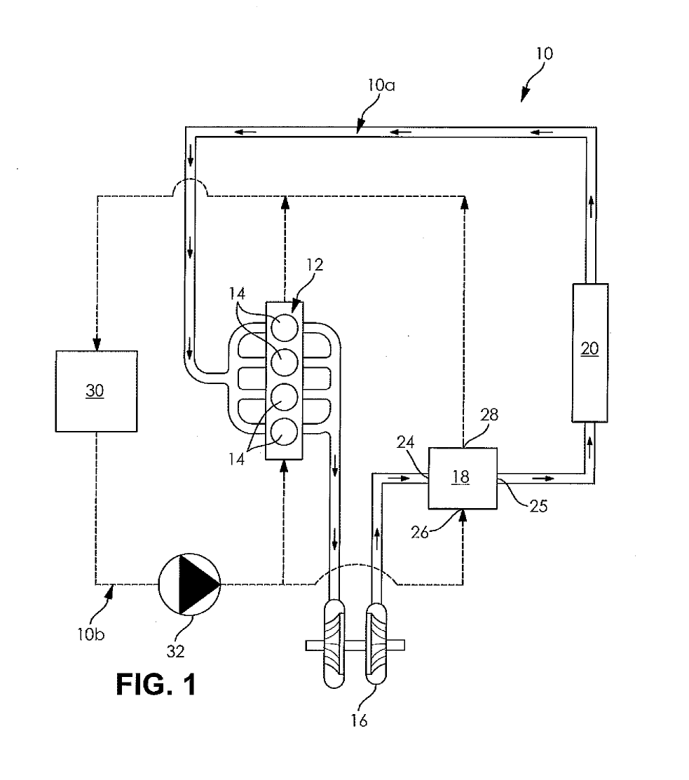

FIG. 1 illustrates a charge air system 10 of a motor vehicle according to an embodiment of the disclosure. The charge air system 10 includes a charge air circuit 10a for containing a flow of air and an engine coolant circuit 10b for containing a flow of a coolant. In the illustrated embodiment of FIG. 1, a direction of the flow of air through the charge air circuit 10a is indicated by solid arrows and a direction of the flow of coolant through the engine coolant circuit 10b is indicated by arrows with dash lines.

The charge air circuit 10a includes an engine 12 which may be configured as an internal combustion engine having a plurality of cylinders 14, a charger 16, a pre-cooler 18, and an air-cooled charge air cooler 20. The engine 12 may be a diesel engine, or a gasoline engine, or other type of engine that may utilize various components in accordance with the present disclosure. The charger 16 is in fluid communication with and disposed upstream from the engine 12 in respect of the flow of air of the charge air circuit 10a. The charger 16 is configured as a turbocharger or a supercharger, for example, and receives and compresses or charges the flow of air prior to being received by the cylinders 14 of the engine 12.

The air-cooled charge air cooler 20 is disposed intermediate the charger 16 and the engine 12 and receives the flow of air of the charge air circuit 10a flowing from the charger 16 to the engine 12. The air-cooled charge air cooler 20 includes a heat exchange core and is configured to cool the flow of air received from the charger 16 by providing heat transfer between the charged flow of air and the ambient air. The air-cooled charge air cooler 20 can be configured as any air-cooled charge air cooler known in the art such as a brick style air-cooled charge air cooler, for example. However, the air-cooled charge air cooler 20 could be a full-faced style air-cooled charge air cooler, a wheel-arched air-cooled charge air cooler, or any other air-cooled charge air cooler as desired. Additionally, the air-cooled charge air cooler 20 can include various tube and/or fin configurations, such as a fin-fin configuration or a tube-tube configuration, for example.

The pre-cooler 18 is disposed intermediate and in fluid communication with the charger 16 and the air-cooled charge air cooler 20. The pre-cooler 18 is separate from the air-cooled charge air cooler 20 and receives the flow of air of the charge air circuit 10a through an air inlet 24 flowing from the charger 16 and conveys the flow of air through an air outlet 25 to the air-cooled charge air cooler 20. The pre-cooler 18 is configured as an engine coolant-cooled high temperature charge air cooler to provide heat transfer from the flow of air to a flow of coolant. In a non-limiting example, the pre-cooler 18 can be an aluminum CAB plate-fin cooler. However, the pre-cooler 18 can be any pre-cooler as desired. The pre-cooler 18 is further in fluid communication with the engine coolant circuit 10b and includes a coolant inlet 26 for receiving the flow of coolant and a coolant outlet 28 for conveying the flow of coolant.

The engine coolant circuit 10b further includes the engine 12, a radiator 30, and a pump 32, all in fluid communication with each other. The radiator 30 is disposed downstream of the engine 12 with respect of a direction of the flow of coolant of the engine coolant circuit 10b and is configured to transfer heat from the flow of coolant to the atmosphere. The pump 32 regulates the flow of coolant flowing through the engine 12 and consequently through the engine coolant circuit 10b. The pre-cooler 18 is in fluid communication with both the pump 32 and the radiator 30, wherein a flow path of the flow of coolant through the engine 12 is disposed in parallel with a flow path of the flow of coolant through the pre-cooler 18.

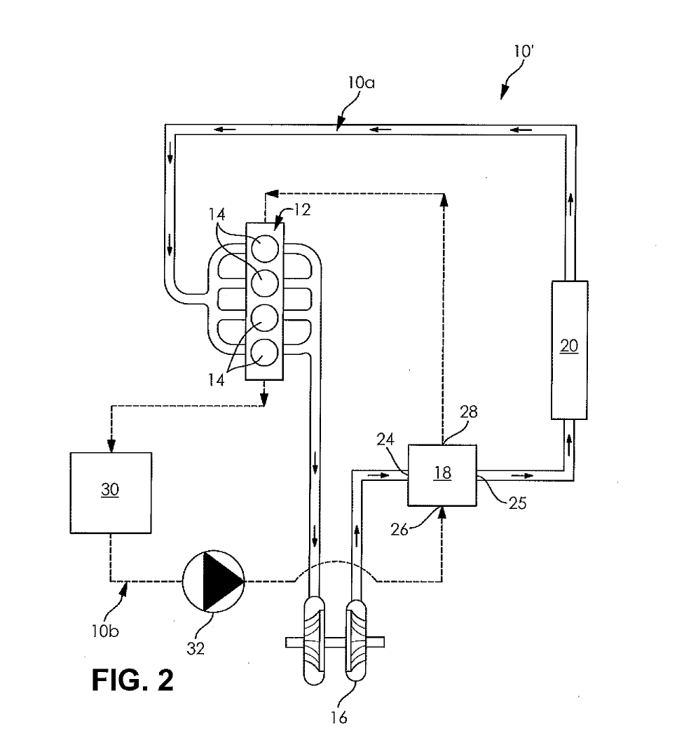

FIG. 2 illustrates a configuration of a charge air system 10′ according to another embodiment of the present disclosure. The same reference numerals are used to describe features substantially similar to those described in FIG. 1. The charge air system 10′ is substantially similar to the charge air system 10 shown in FIG. 1, and described hereinabove, except that that the flow path of the flow of coolant through the engine 12 is in series with the flow path of the flow of coolant through the pre-cooler 18. It is understood the flow path of the flow of coolant through the engine 12 and the flow path of the flow of coolant through the pre-cooler 18 can be configured otherwise, as desired, to transfer heat between the flow of air flowing through the pre-cooler 18 and the coolant flowing through the engine coolant circuit 10b.

It is understood, connections for conveying air between the various components of the charge air circuit 10a (the charger 16, the pre-cooler 18, the air-cooled charge air cooler 20, the engine 12, or other components as desired) can include manifolds, tubing, or piping, as desired or dependent on vehicle requirements. Additionally, connections for conveying the flow of coolant between the various components of the engine coolant circuit 10b (the engine 12, the radiator 30, the pump 32, the pre-cooler 18, etc.) can be manifolds, tubing, or piping, as desired or dependant on vehicle requirements. Configurations and dimensions of the various components of the charge air circuit 10a and the engine coolant circuit 10b such as the pre-cooler 18 and charge air cooler 20 can also be adapted to conform with varying vehicle package spacing requirements. In certain embodiments, while not shown, it is understood the charge air circuit 10a can include other components commonly known for optimizing the charge air system 10 such as control valves, exhaust gas recirculation systems, electronic controls, draining systems, and the like. Likewise, control devices and systems and regulators (such as thermostats, valves, bypass circuits, for example.) can be used in cooperation with the engine coolant circuit 10b as desired.

In operation, coolant is caused to circulate between the radiator 30, the engine 12, and/or the pre-cooler 18 by the pump 32 to cool the engine to militate against overheating and/or seizure. When the coolant flows through the radiator 30, a transfer of heat occurs between the coolant and the atmosphere, thus cooling the coolant. The coolant can then flow through the pump 32 to the engine 12, where heat is transferred from the engine 12 to the coolant, and/or through the pre-cooler 18 where a transfer of heat occurs between the air and the coolant.

Concurrently, with the operation of the engine coolant circuit 10b, the charger 16 receives the flow of air, such as ambient air. The charger 16 compresses or charges the flow of air flowing therethrough. The charger 16 can receive the flow of air having varying ambient temperatures and levels of humidity. For example, the charger 16 can receive the flow of air at high temperatures and at high levels of humidity or the flow of air at high temperatures and low levels of humidly. Likewise, the charger 16 can receive the flow of air at low temperatures and high levels of humidity and low temperatures and low levels of humidity. The charger 16 also operates at varying boost pressure levels depending on varying operating conditions of the vehicle, wherein at a low boost pressure level the charger 16 provides a lower charge or compression to the flow of air, which consequently provides less heat to the flow of air being charged. At a higher boost pressure level, the charger 16 provides a higher charge or compression to the flow of air, which consequently provides more heat to the flow of air being charged. The flow of air being charged then flows from the charger 16 to the pre-cooler 18 through the air inlet 24 thereof and then from the pre-cooler 18 to the air-cooled charge air cooler 20 through the air outlet 25 thereof.

The varying ambient temperatures and levels of humidity of the flow of air and the varying levels of boost pressure of the charger 16 affect the flow of air charged by the charger 16, which affects the performance of the air-cooled charge air cooler 20. The pre-cooler 18 facilitates adjusting the temperatures of the flow of air being charged and flowing through the air-cooled charge air cooler 20 to maximize performance efficiencies.

During certain conditions such as a low boost pressure level of the charger 16, and where an ambient temperature of the flow of air is low and a humidity of the flow of air is high, the pre-cooler 18 warms air flowing from the charger 16 to the air-cooled charge air cooler 20. The warming of the flow of air across the pre-cooler 18 facilitates maintaining the temperature of the flow of air above the dew point temperature and, therefore militates against a formation of condensation on the air-cooled charge air cooler 20. Alternatively, during a high boost pressure level of the charger 16, the temperature of the charged flow of air is higher than a temperature of the flow of coolant of the engine coolant circuit 10b. Therefore, the pre-cooler 18 cools the flow of air flowing from the charger 16 to the air-cooled charge air cooler 20, which boosts the performance efficiency of the air-cooled charge air cooler 20 at a high boost pressure level of the charger 16.

Advantageously, the pre-cooler 18 is configured as a pre-conditioner by cooling the flow of air during a high boost pressure level of the charger 16 or warming the flow of air during a low boost pressure level of the charger 16 when the humidity of the air is high. The configuration improves thermal management of the charge air system 10, 10′ with varying or fluctuating temperatures and humidities of the flow of air being charged. The integration of the pre-cooler 18 with the engine coolant circuit 10b facilitates allowing the pre-cooler 18 to be adapted to varying vehicle package requirements without adding complexity and components. For example, by providing the pre-cooler 18 in fluid communication with the engine coolant circuit 10b, the need for an additional components, such as a pump or a radiator, is eliminated.

From the foregoing description, one ordinarily skilled in the art can easily ascertain the essential characteristics of this invention and, without departing from the spirit and scope thereof, can make various changes and modifications to the invention to adapt it to various usages and conditions.

What is claimed is:

1. A charge air system of a motor vehicle comprising:
a charger disposed in a charge air circuit;
an air-cooled charge air cooler in fluid communication with the charger;
a pre-cooler in fluid communication with the air-cooled charge air cooler; and
an engine coolant circuit in heat exchange communication with the pre-cooler, the engine coolant circuit configured to deliver a flow of coolant through an engine of the motor vehicle.

2. The charge air system of claim 1, wherein the pre-cooler is separate from the air-cooled charge air cooler.

3. The charge air system of claim 1, wherein the pre-cooler is disposed upstream of the air-cooled charge air cooler.

4. The charge air system of claim 1, wherein the pre-cooler is disposed intermediate the air-cooled charge air cooler and the charger.

5. The charge air system of claim 1, wherein the pre-cooler receives the flow of coolant.

6. The charge air system of claim 1, wherein the pre-cooler receives the flow of coolant, wherein a flow path of the flow of coolant through the engine is one of in series with the pre-cooler and in parallel with the pre-cooler.

7. The charge air system of claim 1, wherein the pre-cooler is an engine coolant-cooled high temperature charge air cooler.

8. The charge air system of claim 1, wherein the air-cooled charge air cooler is one of a brick style air-cooled charge air cooler, a wheel-arched air-cooled charge air cooler, and a full-faced style air-cooled charge air cooler.

9. A charge air system of a motor vehicle comprising:
an air charge circuit having a charger, an air-cooled charge air cooler in fluid communication with the charger, and a pre-cooler in fluid communication with and separate from the air-cooled charge air cooler, the pre-cooler disposed upstream of the air-cooled charge air cooler; and
an engine coolant circuit in heat exchange communication with the air charge circuit, the engine coolant circuit conveying a flow of coolant through an engine of the motor vehicle.

10. The charge air system of claim 9, wherein the pre-cooler is disposed intermediate the air-cooled charge air cooler and the charger.

11. The charge air system of claim 9, wherein the pre-cooler receives the flow of coolant.

12. The charge air system of claim 9, wherein the pre-cooler receives the flow of coolant, wherein a flow path of the flow of coolant through the engine is one of in series with the pre-cooler and in parallel with the pre-cooler.

13. The charge air system of claim 9, wherein the pre-cooler is an engine coolant-cooled high temperature charge air cooler.

14. The charge air system of claim 9, wherein the air-cooled charge air cooler is one of a brick style air-cooled charge air cooler, a wheel-arched air-cooled charge air cooler, and a full-faced style air-cooled charge air cooler.

15. A charge air system of a motor vehicle comprising:
a charge air circuit having a charger disposed therein, the charge air circuit configured for delivering a flow of air from the charger to at least one cylinder of an engine of the motor vehicle, the charge air circuit having an air-cooled charge air cooler disposed downstream of the charger and configured for cooling the flow of air prior to the engine;
an engine coolant circuit separate from the charge air circuit and having a radiator disposed therein, the engine coolant circuit configured to deliver a flow of coolant though the engine; and
a pre-cooler in fluid communication with the charge air circuit and the engine coolant circuit, the pre-cooler configured to transfer heat between the flow of air and the flow of coolant.

16. The charge air system of claim 15, wherein the pre-cooler is separate from the air-cooled charge air cooler.

17. A charge air system of claim 15, wherein the pre-cooler is disposed intermediate the air-cooled charge air cooler and the charger.

18. The charge air system of claim 15, wherein the pre-cooler is disposed upstream of the air-cooled charge air cooler.

19. The charge air system of claim 15, wherein the engine coolant circuit includes a pump disposed therein.

20. The method of claim 15, wherein a flow path of the flow of coolant through the engine is one of in series with the pre-cooler and in parallel with the pre-cooler.
